(19) United States
(12) Patent Application Publication
(10) Pub. No.: US 2013/0103223 A1
(43) Pub. Date: Apr. 25, 2013

(54) SWITCHING ON END DEVICES ACCORDING TO NETWORK LOAD

(71) Applicant: Manfred Liebel, Burgthann (DE)

(72) Inventor: Manfred Liebel, Burgthann (DE)

(73) Assignee: SIEMENS AKTIENGESELLSCHAFT, MUENCHEN (DE)

(21) Appl. No.: 13/807,811

(22) PCT Filed: Jun. 29, 2010
(86) PCT No.: PCT/EP2010/059178

§ 371 Date: Dec. 31, 2012

(51) Int. Cl. G05B 13/02

(52) U.S. Cl. CPC G05B 13/02
USPC 700/296

(57) ABSTRACT

An electrical device for connecting to an electrical distribution network of a building. The electrical distribution network is connected to an electrical energy supply network. The electrical device has a switching device for switching on and off an electrical load. For the purpose of relatively simple demand control of the electrical load, the electrical device has a monitoring device for monitoring the voltage and/or frequency at the electrical device on the distribution network side and to generate a switch-on signal if the monitored voltage and/or frequency exceeds an upper threshold value and to generate a switch-off signal if the monitored voltage and/or frequency falls below a lower threshold value. The switching device establishes a current flow between the distribution network and the electrical load when a switch-on signal is present and interrupts a current flow between the distribution network and the electrical load if a switch-off signal is present.

The invention relates to an electrical device for connecting to an electrical distribution system in a building which is connected to an electrical energy supply system, with a switching device, by means of which an electrical load can be switched on and off.

Existing electrical energy supply systems of high-voltage or medium-voltage rating are essentially designed for the transmission of electrical energy from a small number of centralized power generation facilities, e.g. coal-fired power plants, to end users. In energy distribution systems of this type, the direction of transmission is essentially constant; moreover, power generation is adjusted to the forecast and/or actual energy demand of end users.

Recent endeavors and political initiatives have resulted in the deregulation of the electricity market. As a result, increasing numbers of decentralized renewable energy sources, such as wind turbines and photovoltaic installations, have delivered power to medium- or low-voltage systems in recent years, resulting in a radical change to the previously conventional transmission direction. Renewable energy sources of this type are specifically characterized by wide variations in the quantity of electrical energy which they are capable of producing—for example, in high wind conditions, the in-feed of electric power from a wind turbine to the energy supply system may be comparatively large whereas, in low winds or windless conditions, the electric power output may fall to zero.

This problem has previously been resolved e.g. by the provision of “peak-load power plants”, which can be brought into service at times of peak load demand which cannot be covered by existing energy sources. However, the maintenance in reserve and operation of these peak-load power plants, which are only required for service on comparatively rare occasions, is associated with high costs. A further option for the smoothing of variations in the electrical energy available for delivery on the energy supply system associated with the in-feed from fluctuating energy sources involves the use of energy storage facilities, specifically the operation of “pumped storage plants”. In case of a surplus of electrical energy on the energy supply system, storage capacitors can be charged, e.g. by the operation of a pumped storage plant in pumping mode, whereas, in case of a shortage of electrical energy on the energy supply system, energy storage capacitors can be discharged, e.g. by the operation of the pumped storage plant as a hydroelectric generating station. However, as they are associated with specific environmental requirements (two differing levels in close proximity), pumped storage plants of this type cannot be installed universally; other energy storage facilities, e.g. rechargeable electric batteries, are still relatively expensive.

In consequence, recent discussions have increasingly focused on concepts which might be applied for influencing electricity demand by end users. A comparatively old-established method for the targeted control of electricity demand involves the application of special reduced off-peak tariffs, under the terms of which electricity has been supplied at reduced prices at specific times, generally during the night, when demand for electricity is low.

By this arrangement, in the interests of saving on the costs of electricity consumption, the end user is provided with an incentive for operating their electrical appliances during off-peak periods. However, in the light of the fixed definition of time periods for the application of peak and off-peak tariffs, this method is comparatively rigid, and can only be adapted to changing circumstances to a very limited extent. A refinement of demand-side management is provided by “centralized telecontrol”, in which specific consuming devices, e.g. night storage heating systems, can be switched on centrally at times of surplus electricity supply in response to a signal which is modulated by the system voltage; this arrangement may also be associated with preferential tariffs. Many electrical appliances of low and intermediate power rating in the domestic, trade and industrial sectors have yet to be included in the scope of this centralized telecontrol. These appliances continue to be switched on by end users on a purely random basis and as required, with no consideration of the currently available supply of electricity on the energy supply system.

Accordingly, the switchover of energy supply to decentralized and renewable energy sources, with their associated strong variations in availability, necessitates the adoption of new control concepts, which will encompass the distribution of electricity at high- and medium-voltage ratings, and at low-voltage ratings, through to end users of electricity. Control concepts of this type have recently been summarized under the general term of “Smart Grid”. One objective of Smart Grid concepts of this type is the effective management of electricity demand in relation to the electricity available on the energy supply system, thereby permitting e.g. the reduced provision of peak-load power plants. Within the general “Smart Grid” concept, specific arrangements for demand-side management of this type are described as “Demand Response” concepts.

In this connection, a method is known e.g. from US patent specification U.S. Pat. No. 7,188,260 B1 whereby, for the management of electrical loads in an electrical distribution system of a building, control signals are exchanged between a central server, the electrical loads concerned and an electricity meter. By this known method, electricity demand is notified from the electrical loads concerned to the central server which, by means of a bid process, identifies an appropriate electricity provider for the specific take-up of energy required.

This method is relatively expensive and, as an absolute necessity, requires the provision of communication facilities in parallel to the actual energy supply system, in order to permit the transmission of control signals between the electrical loads concerned, the electricity meter and the central server.

Accordingly, the object of the invention is the further development of an electrical device of the type described in the introductory clause, which permits the comparatively straightforward demand-side management of an electrical load.

According to the invention, this object is fulfilled by an electrical device of the type described in the introductory clause, wherein the said electrical device is provided with a monitoring system which is designed to monitor the voltage and/or frequency on the distribution system side of the electrical device, to generate a switch-on signal if the monitored voltage and/or frequency exceeds an upper threshold value, and to generate a switch-off signal if the monitored voltage and/or frequency falls below a lower threshold value, and the switching device is designed, in the presence of a switch-on signal, to permit a flow of current between the distribution system and the electrical load and, in the presence of a switch-off signal, to interrupt the flow of current between the distribution system and the electrical load.

The invention exploits the knowledge that, depending upon system loading and the available supply of energy, the voltage and/or frequency (hereinafter referred to, either individually or collectively, as “system parameters”) on the electrical energy supply system—and, accordingly, on the distribution system of the building—may vary within standardized margins of tolerance in relation to their rated value. A surplus of electrical energy is associated with a raised voltage or frequency in relation to the rated value whereas, in case of a shortage of electrical energy, the voltage or frequency will fall slightly in relation to the rated value. The specific advantage of the electrical device according to the invention is provided in that, for the control of the switching-on and switching-off of the electrical load concerned, no additional communication link to an electricity meter in the distribution system of the building and/or to any overriding control arrangement on the energy supply system is required, as the control response to be applied is identified directly from the monitored system parameters on the distribution system of the building. In consequence, the invention discloses an electrical device which, in a decentralized and independent arrangement, is capable of identifying a surplus or shortage of energy on the energy supply system, and of adjusting its demand for electrical energy accordingly.

In an advantageous further development of the electrical device according to the invention, the switching device is provided with a time-delay element which is designed such that, in case of the presence of a switch-on signal, the establishment of a current flow in the switching device is delayed by a time interval which is dictated by a random timer.

By this arrangement it is possible to ensure that, in case of a rise in voltage or frequency above the upper threshold value, the simultaneous connection of multiple electrical loads will not result in an unwanted peak in load demand, which might itself be responsible for a dip in voltage or frequency on the electrical energy supply system. To this end, the switching device is provided with a time-delay element with a random timer which, in response to the switch-on signal, generates a random time interval by which the switching-on of the electrical load concerned is delayed.

This ensures that electrical loads are switched on gradually, rather than simultaneously.

In this connection, provision may be included for the design of the time-delay element such that the progress of the stipulated time interval is interrupted if, in the course of the said stipulated time interval, the monitored voltage and/or frequency falls below the upper threshold value.

In this way, the connection of further electrical loads, which have yet to be switched on as a result of the persistence of their respective stipulated time delays, can be interrupted if there is no further surplus of electrical energy on the energy supply system. Consequently, the switching-on of further electrical loads will only proceed for such time as a surplus of energy is indicated by a voltage or frequency in excess of the upper threshold value.

In this connection, in a further advantageous form of embodiment, it is provided that the random timer for the generation of time intervals is designed such that the higher the value of the monitored voltage and/or frequency, the shorter the stipulated time interval will be.

By this setting of the random timer with reference to the magnitude of the monitored system parameters, it may advantageously be achieved that rising values in the monitored system parameters are associated with the more rapid connection of individual electrical loads, as higher values for the monitored system parameters are indicative of correspondingly higher surplus quantities of available energy on the electrical energy supply system.

In a further advantageous form of embodiment of the electrical device according to the invention, it may also be provided that the switching device is designed to generate the switch-on signal, even in the presence of a switch-on command whereby the current flow between the distribution system and the electrical load concerned is established independently of the monitored voltage and/or frequency.

To this end, the switch-on command may be generated e.g. manually by a user of the electrical load concerned, or generated automatically by the electrical load itself. For example, it may be provided that an electrical load in the form of a chest freezer forces switch-on by means of the switch-on command where a maximum permissible upper temperature limit is exceeded, regardless of load conditions on the electrical energy supply system. Likewise, for example, a washing machine may commence its wash cycle by means of the switch-on command following the expiry of a maximum waiting time, independently of the load conditions on the electrical energy supply system.

In a further advantageous form of embodiment of the electrical device according to the invention, the said electrical device is provided with an indicator system which provides a visual indication of the presence of a switch-on signal and/or the presence of a switch-off signal.

By this arrangement, an end user of electrical energy may be advantageously informed of relevant load conditions on the electrical energy supply system and adjust their consumption behavior accordingly and, e.g. in case of a surplus of electrical energy on the electrical energy supply system, may proceed to switch on further electrical loads, the connection of which was, in any case, anticipated in the immediate future.

In a further advantageous form of embodiment of the electrical device according to the invention, it is also provided that the electrical load and the electrical device are combined in a single structural unit.

In this case, the electrical load, e.g. a refrigerator, a water heater or a washing machine, incorporates the electrical device and its associated monitoring system and, accordingly, can be directly connected to the electrical distribution system of the building.

In order to allow existing electrical loads to be switched on and off in response to system load conditions as well, it is proposed, in an alternative form of embodiment, that the electrical device be provided with output contacts which are bonded to the switching device, and are appropriate for the electrical connection of the electrical load concerned.

In this case, the electrical device effectively functions as a form of ballast, which may be connected e.g. to a socket on the electrical distribution system of the building, and which itself constitutes a further connection for the electrical load which is switchable by the switching device in response to the monitored system parameters. As the requisite components for the monitoring system and the switching device can be configured with comparatively small dimensions, the dimensions of this ballast can be restricted likewise (to correspond e.g. to those of a conventional socket adapter).

Finally, in a further advantageous configuration of the electrical device according to the invention, it may be provided that the monitoring system is designed to constitute the lower threshold value for the generation of the switch-off signal which is dependent upon a given operating state of the electrical load concerned.

In this case, for example, switching-off of the electrical load may be made conditional upon the potential occurrence of an unwanted operating state as a result of this switching-off. For example, where the electrical load concerned is a chest freezer, the value of the lower threshold may be dictated by the “reserve capacity” of the chest freezer, i.e. the margin between the instantaneous temperature of frozen goods and the maximum permissible temperature. Where the reserve capacity is high, e.g. the temperature of the frozen goods is low, a higher value may be set for the lower threshold, such that the switch-off signal will be generated even in case of minor variations in the system parameters below their rated value.

The invention is described in greater detail below, with reference to examples of execution. To this end:

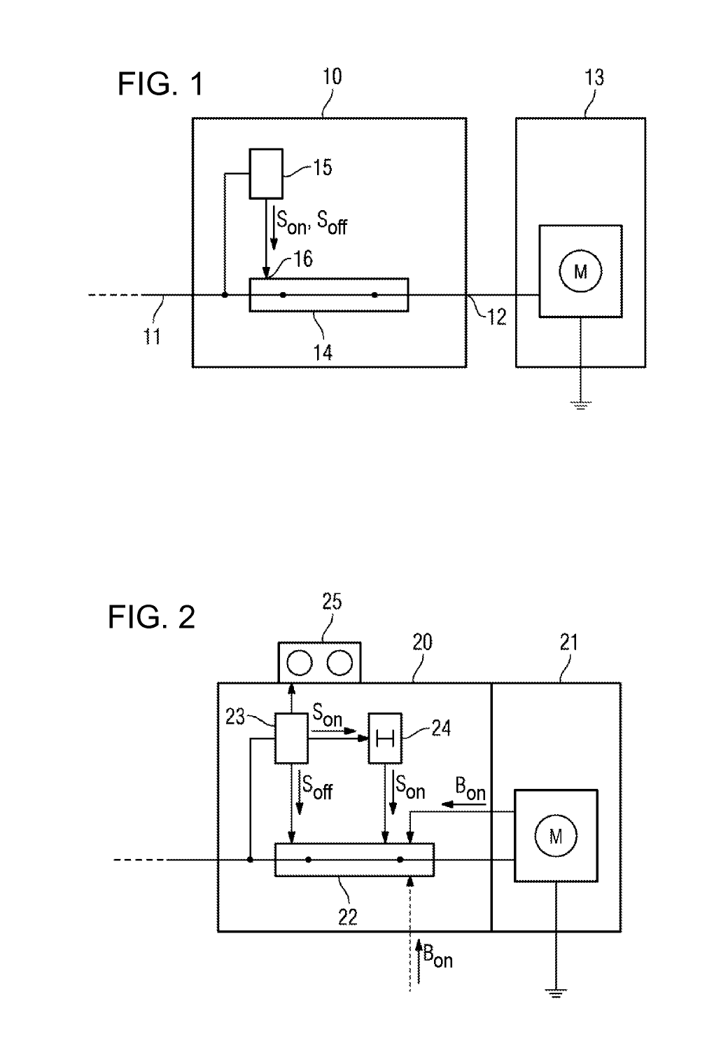

FIG. 1 shows a schematic block diagram of a first exemplary
embodiment of an electrical device, with an electrical load connected;

FIG. 2 shows a schematic block diagram of a second exemplary
embodiment of an electrical device, which is incorporated in an electrical load; and

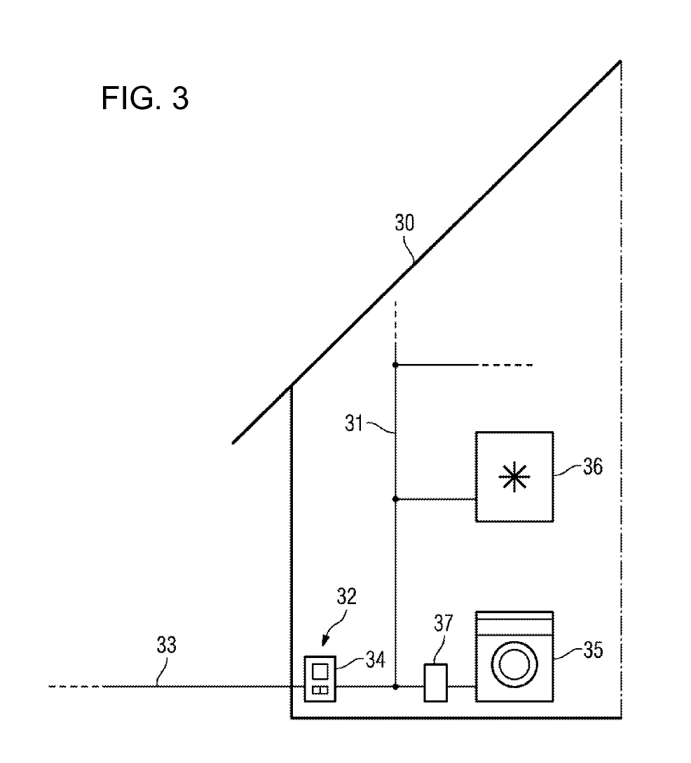

FIG. 3 shows a schematic representation of a building with
an electrical distribution system, to which a number
of electrical loads are connected.

FIG. 1 shows an electrical device 10 which, on the input side, is connected to an electrical distribution system 11 of a building, which is not represented in greater detail. The electrical device 10 is provided with output contacts 12 which, via an electrical connection, are connected to an electrical load 13, represented in FIG. 1, for exemplary purposes only, in the form of an electric motor. Electrical loads may be comprised of any electrical loads which are connectable to a distribution system of a building (e.g. household appliances such as cooling or heating devices, water heaters, air-conditioning installations, pumps, washing machines and dishwashers, but also e.g. industrial kilns and other installations in industrial facilities).

In order to actuate the electrical load 13 in relation to the relevant load situation on an electrical energy supply system to which the distribution system of the building concerned is connected, the electrical device 10 is provided with a switching device 14, which can either establish or interrupt the flow of current between the distribution system 11 and the electrical load 13. The electrical device 10 is also provided with a monitoring system 15, which is designed to monitor system parameters, in the form of voltage and/or frequency, on the distribution system side of the electrical device 10.

By reference to the monitored system parameters, conclusions can be drawn with regard to the load situation on the electrical energy supply system, which is also reflected on the distribution system of the building which is connected to the said energy supply system. Although the voltage or frequency will generally assume a rated value, they may vary in relation to this rated value within a narrow range of tolerance. If the monitored voltage or frequency lies at the upper end of the range of tolerance (above the rated value), there will be a surplus of electrical energy on the energy supply system. Correspondingly, where values for the monitored system parameters lie at the lower end of the range of tolerance (below the rated value), a shortage of electrical energy on the energy supply system is indicated.

This effect is exploited by the electrical device 10 in that, where values for the monitored voltage or frequency exceed an upper threshold value (at the upper end of the range of tolerance), the monitoring system 15 transmits a switch-on signal Sₒₙ to a control input 16 of the switching device 14, whereby the latter initiates the establishment of an electrical contact (e.g. by the closing of a contact) between the distribution system 11 and the output contacts 12, thereby permitting a flow of current to the electrical load 13. Correspondingly, where values for the voltage or frequency lie below a lower threshold value (at the lower end of the range of tolerance), the monitoring system 15 generates a switch-off signal S_{off} and delivers this signal to the control input 16 of the switching device 14, such that the latter initiates the interruption of the current flow between the distribution system 11 and the electrical load 13.

By this mode of operation of the electrical device 10, it is possible for the down-circuit electrical load 13 to be switched on in case of a surplus of electrical energy on the electrical energy supply system and, conversely, for the said load to be switched off in case of a shortage of electrical energy on the electrical energy supply system (e.g. as a result of the limited, or even zero in-feed of power from renewable energy sources). The electrical device is provided with a specific advantage, in that no communication link to an electricity meter or to a control device on the electrical energy supply system is required for actuating the switching device.

FIG. 2 shows a further exemplary embodiment of an electrical device 20. Whereas the electrical device 10 represented in FIG. 1 effectively constitutes a form of ballast for a separate electrical load 13, the electrical device 20 and a down-circuit electrical load 21 represented in FIG. 2 are combined in a single unit.

As the mode of operation of the electrical device 20 represented in FIG. 2 essentially corresponds to the mode of operation described above with reference to FIG. 1, the description of FIG. 2 will focus specifically upon the differences involved.

In common with the electrical device 10 represented in FIG. 1, the electrical device represented in FIG. 2 is provided with a switching device 22, which is actuated by means of a switch-on signal Sₒₙ generated by a monitoring system 23, and by means of a switch-off signal S_{off} generated by the said monitoring system 23. However, there is a distinction from the representation shown in FIG. 1, in that the switch-on signal Sₒₙ is routed in the first instance to a time-delay element 24, which delays the further transmission of the switch-on signal Sₒₙ to the switching device 22 by a stipulated time interval. This time interval is defined by a random timer (not explicitly represented), which is incorporated in the time-delay element and contains a random-variable generator, and which, in response to the presence of a switch-on signal Sₒₙ on the input side of the time-delay element 24, defines a randomly generated time interval as a parameter for the time-delay element 24. The further transmission of the switch-on signal Sₒₙ to the switching device 22 is delayed by this randomly generated time interval. This arrangement is intended to ensure that, even in the case of multiple electrical loads, which are switched on in the same way as the electrical load 21 in response to the monitored system parameters, there will be no peaks in load demand associated with the simultaneous switching-on of all the electrical loads concerned. By means of the randomly generated time delay, electrical loads are switched on gradually, such that the stability of the energy supply system is maintained.

It may also be provided that, where the monitored system parameters dip below the upper threshold value (i.e. indicating that there is no longer a surplus of electricity) during the progress of the stipulated time interval, the progress of the said time interval is interrupted, with no further transmission of the switch-on signal Sₒₙ to the switching device 22. This ensures that, in case of a surplus of electrical energy on the energy supply system, only so many electrical loads will be switched on as can be served by the said surplus.

The time-delay element 24 may also be designed such that the higher the value of the monitored voltage or frequency, the smaller the time interval generated. By this arrangement, in case of a large surplus of electrical energy, numerous electrical loads can be connected within a comparatively short space of time.

Conversely to the switch-on signal Sₒₙ, the switch-off signal S_{off} is transmitted directly from the monitoring system 23 to the switching device 22, i.e. without the interposition of the time-delay element.

In the exemplary embodiment represented in FIG. 2, it is also provided that the electrical load 21 itself may generate a switch-on command Bₒₙ, where the override execution of a switch-on function by the switching device 22 is to be enforced. To this end, the switching device 22 is designed such that, in the presence of the switch-on command Bₒₙ, a flow of current to the electrical load will also be established. A switch-on command Bₒₙ of this type may be generated by the electrical load 21, e.g. where an undesirable operating state would otherwise exist on the electrical load 21 concerned, for example where the temperature in a chest freezer has reached its maximum permissible value. A switch-on command Bₒₙ may also be generated upon the expiry of a permissible waiting time, e.g. following the loading of a washing machine, in order to deliver an acceptable result to the user of the electrical load 21 concerned (e.g. the completion of a washing cycle within a maximum of three hours following the loading of the washing machine).

A switch-on command Bₒₙ may also be generated manually by the user of the electrical load 21 concerned, e.g. by means of a pushbutton on the electrical device 20.

The electrical device 20 represented in FIG. 2 is also provided with an optical indicator system 25, which may be actuated by the monitoring system 23, in order to indicate the presence of a switch-on signal Sₒₙ and/or of a switch-off signal S_{off} to the user of the electrical device 20. This may be achieved by means of a green LED (indicating the presence of a switch-on signal) and/or a red LED (indicating the presence of a switch-off signal). Depending upon the status of the optical indicator system 25, the user of the electrical device 20 can adjust their own energy consumption behavior accordingly and deliberately switch on or off further electricity consuming devices.

Finally, FIG. 3 shows a schematic representation of a building 30 with an electrical distribution system 31, which is connected at an interchange point 32 to an electrical energy supply system 33, which is not represented in any greater detail. In the vicinity of the interchange point 32, a centralized electricity meter 34 is arranged, which records the take-up of electrical energy by the distribution system 31 of the building 30.

Electrical loads in the form of a washing machine 35 and a chest freezer 36—represented in FIG. 3 by way of examples only—are connected to the distribution system 31 of the building 30. Further electrical loads may naturally be present, although not represented on FIG. 3.

Whereas the chest freezer 36 is provided with an integrated electrical device (e.g. in accordance with one of the two exemplary embodiments described above), the washing machine 35 is connected to the distribution system via an electrical device 37 which is configured in the form of ballast. The mode of operation of the actuation of the electrical loads 35 and 36 corresponds to that described above with reference to FIGS. 1 and 2 and, accordingly, will not be repeated here. Attention is specifically drawn to the fact that, for the described system load-dependent actuation of the electrical loads 35 and 36, no communication link to the electricity meter 34 or to a control device on the electrical energy supply system 33 is required.

In general, it may be observed that electrical loads with a storage capability, such as e.g. refrigerators and freezers, water heaters, industrial kilns or heat pumps, which operate in tandem with a buffer facility, are specifically suitable for the prevention of peaks in load demand on the electrical energy supply system by the mode of operation envisaged, whereby their energy demand can be substantially covered during phases of surplus energy supply, and their reconnection during periods of a shortfall in available energy on the energy supply system can be delayed insofar as possible. However, other electrical loads, the switching-on of which can be deferred within specific limits in the course of the day, such as e.g. washing machines and dishwashers, can also make a worthwhile contribution to the optimization of the energy supply system by the method of actuation envisaged.

In the case of electrical loads which are controlled with reference to limit values, e.g. for the temperature of frozen goods, heat-up, fullness, etc., it is advantageous that, during periods where there is a surplus of energy, these limit values should be raised to their maximum permissible value, such that, during a subsequent period of energy shortfall, connection to supply in response to a fall in variables below their minimum permissible values can be avoided to the greatest possible extent. These minimum values can also be reduced to their lowest permissible limit values by the proposed electrical device, with reference to the energy supply, in order to prevent connections during a dip in energy supply to the maximum possible extent.

Depending upon the type of electrical load concerned, “load-shedding classes” may also be defined as parameters for the monitoring system, specifically for the determination of the level of the lower threshold value. For example, it is possible for electrical loads, the disconnection of which would have a limited impact to be assigned to a load-shedding class in which a correspondingly higher level for the lower threshold value can be applied (i.e. a threshold value which dictates a response to smaller deviations). Correspondingly, electrical loads, the disconnection of which is undesirable can be assigned to another load-shedding class in which a lower level for the lower threshold value is applied. Accordingly, the process can be set to proceed with reference to the upper threshold value.

In the case of electrical loads with a storage capability, the lower threshold value can also be dynamically adjusted to the relevant operating conditions in force. In this case, for example, the switching-off of the electrical load may be made conditional upon the potential occurrence of an unwanted operating state as a result of this switching-off. For example, where the electrical load concerned is a chest freezer, the value of the lower threshold may be dictated by the “reserve capacity” of the chest freezer, i.e. the margin between the instantaneous temperature of frozen goods and the maximum permissible temperature. Where the reserve capacity is high, e.g. the temperature of the frozen goods is low, a higher value may be set for the lower threshold, such that the switch-off signal will be generated even in case of minor variations in the system parameters below their rated value.

As an incentive for end users to employ the electrical device described, the electrical energy supply system operator may also offer variable tariffs for the supply of electricity, which are adapted to the relevant system conditions in force.

The electrical device described has a further advantage, in that its mode of operation, in contrast with other systems for the operational optimization of an energy supply system, is not dependent upon the status of the energy supply system as a whole, but involves system optimization on the basis of specific local energy supply conditions, e.g. in consideration of disturbances associated with large consumers in the immediate locality and local renewable energy sources. Accordingly, transmission losses on the energy supply system are further reduced.

1-9. (canceled)

10. An electrical device for connecting to an electrical distribution system in a building, wherein the electrical distribution system is connected to an electrical energy supply system, the electrical device comprising:
a switching device configured to selectively switch an electrical load on and off;
a monitoring system configured to monitor a voltage and/or a frequency on a distribution system side of the electrical device, to generate a switch-on signal if the monitored voltage and/or frequency exceeds an upper threshold value, and to generate a switch-off signal if the monitored voltage and/or frequency falls below a lower threshold value; and
said switching device, when the switch-on signal is present, permitting a flow of current between the distribution system and the electrical load and, when the switch-off signal is present, interrupting the flow of current between the distribution system and the electrical load.

11. The electrical device according to claim 10, which comprises a time-delay element configured to, when the switch-on signal is present, delay an establishment of a current flow in said switching device by a time interval that is dictated by a random timer.

12. The electrical device according to claim 11, wherein said time-delay element is configured such that a progress of a stipulated time interval is interrupted if, in the course of the stipulated time interval, the monitored voltage and/or frequency falls below the upper threshold value.

13. The electrical device according to claim 11, wherein the random timer for generating the time interval is configured such that the higher the value of the monitored voltage and/or frequency, the shorter the stipulated time interval will be.

14. The electrical device according to claim 10, wherein said switching device is configured to generate the switch-on signal, even in the presence of a switch-on command that stipulates that a current flow between the distribution system and the electrical load should be established independently of the monitored voltage and/or frequency.

15. The electrical device according to claim 10, which comprises an indicator system for displaying a visual indication of the presence of a switch-on signal and/or the presence of a switch-off signal.

16. The electrical device according to claim 10, wherein said electrical load and said electrical device are combined in a single structural unit.

17. The electrical device according to claim 10, wherein said electrical device comprises output contacts bonded to said switching device, and configured for electrically connecting the electrical load.

18. The electrical device according to claim 10, wherein said monitoring system is configured to establish the lower threshold value for the generation of the switch-off signal that is dependent upon a given operating state of the electrical load.
